(19) United States
(12) Patent Application Publication
(10) Pub. No.: US 2020/0010214 A1
(43) Pub. Date: Jan. 9, 2020

(54) PORTABLE LANDING AND TAKE-OFF PAD FOR AN UNMANNED AIR AERIAL VEHICLE

(71) Applicant: Royce Newcomb, Cameron Park, CA (US)

(72) Inventor: Royce Newcomb, Cameron Park, CA (US)

(21) Appl. No.: 16/573,453

(22) Filed: Sep. 17, 2019

Related U.S. Application Data
(60) Provisional application No. 62/663,747, filed on Apr. 27, 2018.

(51) Int. Cl. B64F 1/00; B64F 1/20; B64C 39/02; B64F 5/60; B64D 45/08; B64F 1/36; B60L 53/80; B60L 53/51

(52) U.S. Cl. CPC B64F 1/007; B64F 1/20; B64C 39/024; B64F 5/60; B60L 2200/10; B64F 1/362; B60L 53/80; B60L 53/51; B64C 2201/128; B64D 45/08

(57) ABSTRACT

The present invention is directed to a drone based delivering system comprising a drone and a portable landing pad for landing and take-off of the drone. The portable landing pad comprising GPS guided lasers for guiding the drone to safely land on the landing pad, and wherein the drone is having GPS guided laser electronic receivers for receiving the laser beams from the GPS guided lasers. The drone further comprises a battery replacement system, wherein the drone swaps its discharges battery with a charges battery already docked in the portable landing pad.

### FIELD OF THE INVENTION

The subject matter of the present invention relates generally to a drone or unmanned air aerial vehicle based delivery system and, more particularly, to a GPS laser-guided landing and take-off of a drone when performing delivery and/or pick-up of an item at a designated location.

### BACKGROUND OF THE INVENTION AND THE PRIOR ART

In recent time, the concept of delivery of items through drones and other remote controlled flying delivery devices has emerged. Further, drones are convenient for high-speed point-to-point delivery and significantly save cost and labor. For the optimal implementation of such devices, there is a need to communicate to them a specific location at which to deliver and/or pick-up a parcel or other object.

Despite its many advantages, one of the potential problems of using drones to deliver or receive packages is that the drones are prone to damages when performing the landing. Also, the existing drones are vulnerable to damages from malicious actors in the form of theft and damage and destruction of property of the product and the drone itself. The drone has to precisely determine suitable landing surface using multiple sensors. The deployment of such sensors increases the cost of drone delivery systems. Moreover, the drone may face obstacles while delivering the package to the ground level, which may harm the drone as well as the package. Also, in populated areas, the drone may be unable to determine suitable landing area, thus preventing certain areas from receiving deliveries. Therefore, in order to overcome one or more of above-identified problems of known drone-based delivery systems, there is strong felt a need for an improved drone-based delivery system that is more safer, efficient and user-friendly.

### SUMMARY OF THE INVENTION

Few of the objects of the present invention are as stated below:
It is an object of the present invention to provide a drone-based delivery system wherein a drone is landed smoothly and safely.
It is an additional object of the present invention to provide a drone-based delivery system wherein the system enables the drone to run for a longer time by replacing its existing battery by a charged battery automatically.
It is still further object of the present invention to provide a drone-based delivery system wherein the system uses GPS guided lasers for better navigation and landing of the drone.
It is still further object of the present invention to provide a drone-based delivery system wherein the landing pad is portable and can be placed on any desired location without any hassle.

Certain embodiments of the present invention are directed to a drone-based delivery system for delivering and/or receiving an item from a user defined location.

Principally, in accordance with a primary aspect of the present invention, the drone-based delivery system comprises a portable landing pad at the destination location for landing of the drone. The portable landing pad comprises a flat platform on which the drone is received. Furthermore, the portable landing pad comprises GPS guided lasers which guide the drone to the portable landing pad. The portable landing pad emits laser beams and the drone have electronic receivers which receive the signals transmitted by the portable landing pad via laser beams and follows the laser beams till the landing. The drone easily lands on the portable landing pad by following laser guides.

Once the drone landed on the platform of the portable landing pad, the drone releases the item on the platform. The drone after releasing the item on the platform follows the same GPS guided laser beams and take off

According to another aspect of the present invention, the drone has an automatic battery switching system. The portable landing pad has a charged battery on standby. When the drone reaches the portable landing pad, a sensor detects the battery percentage of the drone, and if the battery percentage is not enough to reach the next destination of the drone, the automatic power battery switching system swaps the existing discharged battery of the drone by the charged battery already docked on the portable landing pad.

The foregoing has outlined, rather broadly, the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE ACCOMPANYING DRAWINGS

Embodiments of the present disclosure will be described more fully hereinafter with reference to the accompanying drawings in which like numerals represent like elements throughout the figures, and in which example embodiments are shown:

FIG. 1 is a perspective view of a portable landing pad, according to an embodiment of the present invention.

FIG. 2 shows the portable landing pad in the folded configuration, in accordance with an embodiment of the present invention.

FIG. 3 illustrates a drone guided by GPS guided lasers for landing on the portable landing pad, in accordance with an embodiment of the present invention.

FIG. 4 illustrates the drone of FIG. 3 landed on the portable landing pad.

FIG. 5 illustrates a charged battery docked in the portable landing pad, in accordance with an embodiment of the present invention.

FIG. 6 Illustrate the drone taking off from the portable landing pad while leaving the discharged battery docked in the portable landing pad.

### DETAILED DESCRIPTION

In order to ameliorate and overcome one or more drawbacks and disadvantages associated with the prior art and to provide additional advantages, an advanced drone-based delivery system is provided and illustrated herein in the form of a non-limiting and exemplary embodiments. Additional features and advantages are realized through the techniques of the disclosure of the present invention. Other embodiments and aspects of the disclosure of the present invention are described in detail herein and are considered a part of the claimed invention.

The detailed description and the drawings illustrate specific exemplary embodiments by which the disclosure may be practiced. These embodiments are described in detail to enable those skilled in the art to practice the disclosure. It is understood that other embodiments may be utilized, and other changes may be made, without departing from the spirit or scope of the present disclosure. The following detailed description is therefore not to be taken in a limiting sense, and the scope of the present disclosure is defined by the appended claims. Embodiments of the claims may, however, be embodied in many different forms and should not be construed as limited to the embodiments set forth herein.

Embodiments of the disclosure are discussed below with reference to the Figures. However, those skilled in the art will readily appreciate that the detailed description given herein with respect to these figures is for explanatory purposes as the disclosure extends beyond these limited embodiments. For example, it should be appreciated that those skilled in the art will, in light of the teachings of the present disclosure, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the disclosure that are too numerous to be listed but that all fit within the scope of the disclosure. Also, singular words should be read as plural and vice versa and masculine as feminine and vice versa, where appropriate, and alternative embodiments do not necessarily imply that the two are mutually exclusive.

It is to be further understood that the present disclosure is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present disclosure. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means.

Unless defined otherwise, all technical and scientific terms used herein have the same meanings as commonly understood by one of ordinary skill in the art to which this disclosure belongs. Preferred methods, techniques, devices, and materials are described, although any methods, techniques, devices, or materials similar or equivalent to those described herein may be used in the practice or testing of the present disclosure.

References to “one embodiment,” “an embodiment,” “example embodiment,” “various embodiments,” etc., may indicate that the embodiment(s) of the disclosure so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching.

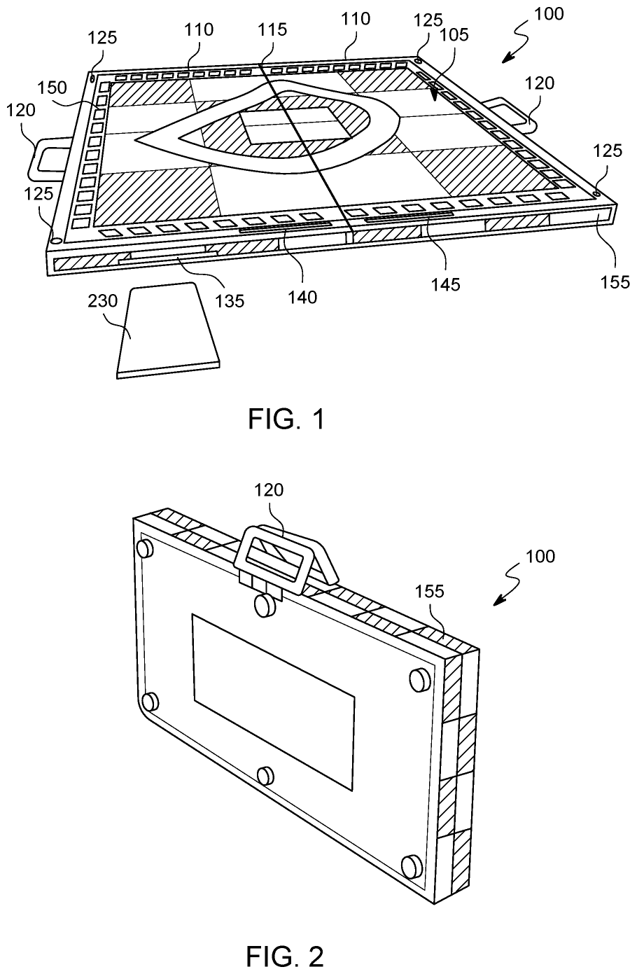

Referring to FIG. 1 to FIG. 6, a drone-based delivery system is described in accordance with a most preferred embodiment of the present disclosure. The drone-based delivery system comprises portable landing pad 100 and a drone 200. The portable landing pad 100, as shown in FIG. 1, includes a flat surface platform 105 for receiving the drone 200. The drone 200 is landed on the platform 105, which is of the size in accordance with the size of the drone 200 to be received. Typically the sizes of the drones, as well as the packages (items), the drones have to carry are generally set by the company. Accordingly, the platforms of standard sizes can be produced.

The portable landing pad 100 shown in FIG. 1 is square shaped and of predetermined thickness. The platform 105 is made of two rectangular sections 110 which are foldably coupled to each other along the fold line 115. For example, the two sections 110 can be joined through one or more hinge joints (not shown) which permits the two sections 110 to pivot toward each other. FIG. 2 shows the portable landing pad 100 folded for its easy handling and transportation.

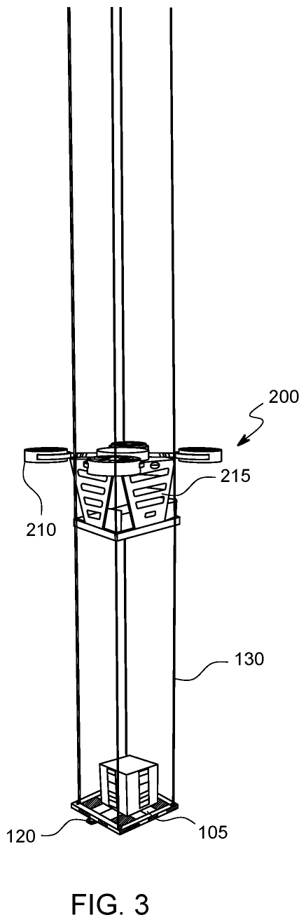

Further shown in FIGS. 1 and 2 are two handles 120, each coupled to the two sections 110, on opposite ends of the portable landing pad 100. The handles 120 are positioned such that when the two sections 110 are folded, the two handles 120 faces each other, as shown in FIG. 2. The portable landing pad 100 may further be provided with locks (not shown) for locking the two sections 110 of the portable locking pad 100 in the folded configuration. Further can be seen in FIG. 1 is GPS guided lasers 125 disposed at four corners of the platform 105. The GPS guided lasers 125 directs laser beams 130 (shown in FIG. 3) for guiding the drone 200 to the portable landing platform 100. When the portable landing pad 100 activates the GPS guided lasers 125, electronic receivers mounted inside the drone 200 receives the signals transmitted by the portable landing pad 100 via GPS guided lasers 125 and follows the signals for a safe landing. The drone 200 easily lands on the platform 105 by following the GPS guided lasers 125. It is to be understood that the Figures shows the laser beam 130 as solid lines, it is obvious that the laser beams may be visible or invisible to naked human eyes. Moreover, GPS guided lasers 125 are shown to be positioned at corners of the platform 105. Alternatively, the GPS guided lasers 125 can also be positioned at any other location on the platform 105 and, in addition, one or more than one GPS guided laser can be embodied in according to the present invention. FIG. 3 shows the drone 200 being guided by the GPS guided laser 125 for landing on the platform 105. The drone 200 shown in FIG. 3 is carrying an item 205 for delivering to the user location.

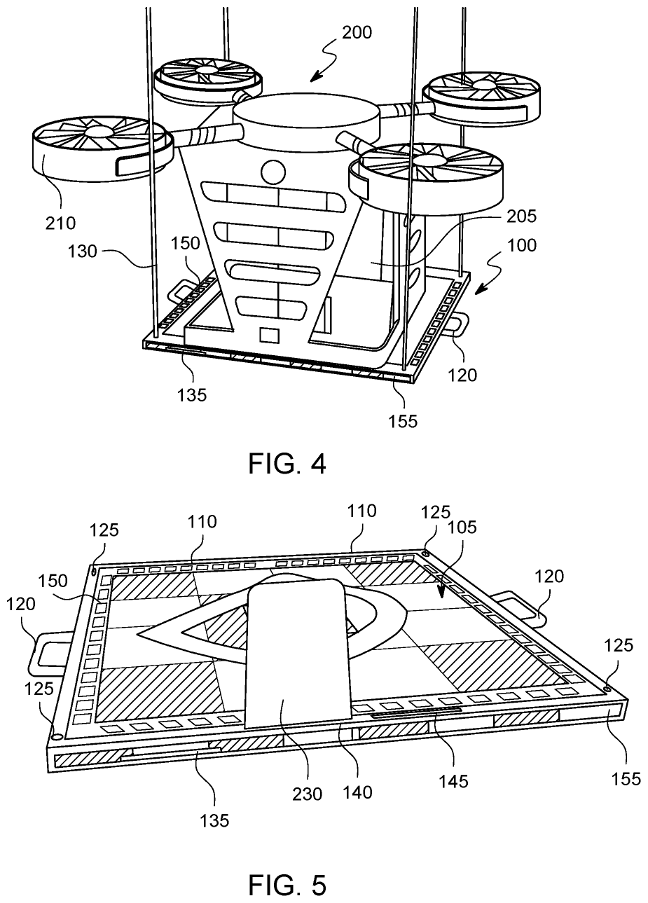

Once the drone 200 is landed on the portable landing pad 100 (Shown in FIG. 4), the drone 200 releases the item 205 on the platform 105. The drone 200 after releasing the item 205 on the platform 105 follows the GPS guided lasers beams 130 to safely take off. Once the drone 200 take-offs safely, the user can collect the item 205 from the portable landing platform 100. The drone 200 follows the path guided by the GPS guided lasers 125 to safely take off

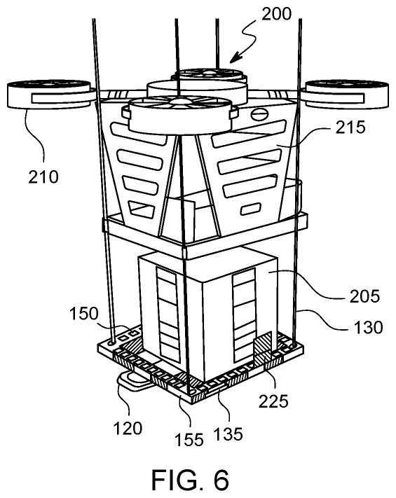

FIG. 4 shows the drone 200 landed on the platform 105. The drone 200 is having four fans 210 for lifting the drone 200 and a holding mechanism 215 for holding the item 205. The drone 200 is made of robust and weather resistant material so that it can survive in harsh weather conditions. Furthermore, the drone body is made of hard material so that it can avoid any chances of damages caused by malicious person and the drone fly high enough to avoid collision with any object come in the way between the source station and the destination station. The drone 200 is having four electronic receivers (Not Shown) to receive the GPS guided laser 125 emitted by the portable landing pad 100. The drone further comprises an automatic battery switching system (not shown). When the drone 200 reaches at the portable landing pad 100, a sensor (not shown) detects the battery percentage of the drone 200, and if the battery percentage is not sufficient to reach the next destination of the drone 200, the automatic battery switching system swaps the discharged battery 225 of the drone by a charged battery 230 already docked in the in-dock 140 of the portable landing pad 100. FIG. 5 shows the charged battery 230 docked in the in-dock 140 of the portable landing pad 100. The discharged battery 225 of the drone is received in the out-dock 145 of the portable landing pad 100. FIG. 6 shows the drone 200 taking off the portable landing pad 100. The drone 200 can be seen following the laser beams 130 for a safer take-off. Further can be seen in FIG. 6 is the discharged battery 225 left by the drone 200 in the dock-out 145. So, now the drone 200 never run out of battery in midway. The discharged battery 225 can then be inserted in the charging dock 135 for charging.

Further can be seen in FIG. 1 is solar panels modules 150 disposed near the edges of the platform 105. The solar panel modules 150 are configured to collect solar energy and store the same in batteries (not shown) of the portable landing pad. These batteries are different from the drone's batteries and used to power the portable landing pad 100. Conversion and storage of solar energy using solar panels and batteries are obvious to a skilled person.

Warning indicators 155 can be seen in FIG. 1 along with the edges of the platform 105. The portable landing pad 100 may further comprise warning indicators 155 disposed along the platform 105. The indicators 155 start blinking when the drone is nearby and approaching the portable landing platform 100. Purpose of the indicators 155 is to warn the user or nearby person, that the drone is approaching the portable landing platform 100.

According to various embodiment of the present disclosure, the drone is having electronic receivers which follow said GPS guided laser beams for pin-point accuracy in landing and take-offs.

Usually, many modifications and other embodiments of the invention will come to the mind of one skilled in the pertinent art having the benefit of the teaching presented in the foregoing descriptions and the associated drawings. Therefore, it is understood that the invention is not limited to the specific embodiments disclosed and that modifications and variations of the disclosed embodiments are intended to be included as readily appreciated by those skilled in the pertinent art. It is contemplated that these modifications and variations be included within the scope and ambit of the instant invention which is defined by the following claims.

We claim:

1. A portable landing pad for landing of a drone, the portable landing pad comprising:
a platform having a flat surface for receiving a drone; and
a plurality of GPS guided lasers disposed at near edges of the platform and configured for guiding the drone to land and/or take off from the platform;

2. The portable landing pad of claim 1, wherein the portable landing pad further comprises a plurality of solar panels coupled to the platform.

3. The portable landing pad of claim 1, wherein the portable landing pad further comprises a charging dock for charging and storing a drone's battery.

4. The portable landing pad of claim 3, wherein the portable landing pad further comprises an in-dock and out-dock, the in-dock is configured to mount the charged drone's battery, the out-dock is configured to receive a discharged battery from the drone.

5. The portable landing pad of claim 1, wherein the portable landing pad further comprises a plurality of warning lights coupled to the platform.

6. The portable landing pad of claim 1, wherein the platform is comprised of a pair of sections foldably coupled.

7. The portable landing pad of claim 6, wherein each of the pair of sections comprise a handle.

8. The portable landing pad of claim 1, wherein the portable landing pad comprises four GPS guided lasers disposed at four corners of the platform.

9. The portable landing pad of claim 1, wherein the portable landing pad is square shaped.

10. A drone based delivering system comprising:
a drone, the drone comprising:
a battery switching system; and
GPS guided laser electronic receivers;
a spare drone's battery; and
a portable landing pad, the portable landing pad comprises:
a platform having a flat surface for receiving a drone; and
a plurality of GPS guided lasers disposed at near edges of the platform and configured for guiding the drone to land and/or take off from the platform.

11. The drone based delivering system of claim 10, wherein the portable landing pad further comprises a charging dock for charging and storing the spare drone's battery.

12. The drone based delivering system of claim 10, wherein the portable landing pad further comprises an in-dock and out-dock, the in-dock is configured to mount the spare drone's battery, the out-dock is configured to receive a discharged battery from the drone.
